(19) United States
(12) Patent Application Publication
(10) Pub. No.: US 2026/0194150 A1
(43) Pub. Date: Jul. 9, 2026

(54) 5-WAY FLOW CONTROL VALVE

(71) Applicant: MYUNG HWA IND. CO., LTD., Seoul (KR)

(72) Inventors: Yu Man WON, Suwon-si (KR); GI HUN HYUN, Incheon (KR); DONG JUNE KANG, Incheon (KR)

(73) Assignee: MYUNG HWA IND. CO., LTD., Seoul (KR)

(21) Appl. No.: 19/432,084

(22) Filed: Dec. 23, 2025

(30) Foreign Application Priority Data
Jan. 7, 2025 (KR) 10-2025-0002024

(51) Int. Cl. F16K 11/16; H01M 8/04746

(52) U.S. Cl. CPC F16K 11/166; H01M 8/04768

(57) ABSTRACT

A 5-way flow control valve includes a valve housing including a first flow path communicating with the coolant pump, a second flow path communicating with the fuel cell stack, a third flow path communicating with the radiator, a fourth flow path communicating with the ion filter, and a fifth flow path communicating with the heater; a lower valve body configured to selectively rotate inside the valve housing to adjust opening and closing and opening degrees of the first flow path, the second flow path, and the third flow path of the valve housing; an upper valve body stacked above the lower valve body; and an actuator located outside the valve housing and connected to at least one of the upper valve body and the lower valve to rotate the lower valve body and the upper valve body.

### CROSS-REFERENCE TO RELATED APPLICATION

This application is based on and claims priority under 35 U.S.C. §119 to Korean Patent Application No. 10-2025-0002024, filed on January 7, 2025, in the Korean Intellectual Property Office, the disclosure of which is incorporated by reference herein in its entirety.

### BACKGROUND

### Technical Field

The present disclosure relates to a 5-way flow control valve, and more particularly, to a 5-way flow control valve in which a lower valve body and an upper valve body, which are vertically stacked and formed as one body, rotate about a central shaft according to an operation mode and multiple flow paths (valves) are interconnected and opened and closed.

### Background Art

In general, a fuel cell system applied to a hydrogen fuel cell vehicle includes a fuel cell stack that generates electrical energy from an electrochemical reaction of reactant gases; a hydrogen supply device that supplies hydrogen to the fuel cell stack as fuel; an air supply device that supplies air including oxygen, which is an oxidizer necessary for the electrochemical reaction, to the fuel cell stack; and a thermal management system (TMS) that discharges heat, which is a byproduct of the electrochemical reaction of the fuel cell stack, to the outside to optimally control an operation temperature of the fuel cell stack and performs a coolant management function.

The TMS includes a pump, a cathode oxygen depletion (COD) heater, an ion filter, valves, and a controller in a modular configuration to enable implementation of a cooling loop, a temperature-raising loop, a filter loop, or the like that circulates coolant differently depending on states of a fuel cell vehicle.

In this way, the conventional fuel cell thermal management system includes two or more valves separately, such as a four-way valve and a three-way valve, and thus, there is a disadvantage in that a housing volume of a modular fuel cell thermal management system increases because a separate mounting space is required for each valve, and in addition, there is an issue that the disadvantage hinders the achievement of lightweight and compact of the thermal management system that is a modular components of a fuel cell vehicle.

Also, there is an issue that the individual opening and closing of the four-way and three-way valves complicates a valve control logic for flow control.

Related art includes Korea Patent Publication No. 10-2019-0064739 (June 11, 2019).

### SUMMARY

The present disclosure provides a 5-way flow control valve in which a lower valve body and an upper valve body, which are vertically stacked and formed as one body, rotate about a central axis according to an operation mode and multiple flow paths (valves) are interconnected and opened and closed to operate a fuel cell thermal management system with a single valve.

Additional aspects will be set forth in part in the description which follows and, in part, will be apparent from the description, or may be learned by practice of the presented embodiments of the disclosure.

A 5-way flow control valve according to the present disclosure includes a valve housing including a first flow path communicating with the coolant pump, a second flow path communicating with the fuel cell stack, a third flow path communicating with the radiator, a fourth flow path communicating with the ion filter, and a fifth flow path communicating with the heater; a lower valve body configured to selectively rotate inside the valve housing to adjust opening and closing and opening degrees of the first flow path, the second flow path, and the third flow path of the valve housing; an upper valve body stacked above the lower valve body and configured to selectively rotate inside the valve housing to adjust opening and closing and opening degrees of the fourth flow path and the fifth flow path of the valve housing; and an actuator located outside the valve housing and connected to at least one of the upper valve body and the lower valve to rotate the lower valve body and the upper valve body, which are stacked to each other and formed as one body, about a center axis according to an operation mode.

Here, the lower valve body may have a ball valve shape.

In addition, the upper valve body may include a rotational shaft extending vertically at a center of an internal space of the upper valve body, and may be divided into three spaces by three partition walls radially arranged around the rotational shaft.

Here, each of the three internal spaces of the upper valve body may communicate with an internal space of the lower valve body.

Also, the actuator may rotate the lower valve body and the upper valve body about the rotational shaft according to one of a long-steel plate operation mode, a temperature control operation mode, a filter closing operation mode, and a high-output operation mode based on an angle of the rotational axis in a cold-start operation mode.

Here, the actuator may not rotate the lower valve body and the upper valve body in the cold-start operation mode, may rotate, in the long-steel plate operation mode, the lower valve body and the upper valve body by a first angle based on an angle of 0° in the cold-start operation mode, rotates the lower valve body and the upper valve body by a second angle greater than the first angle in the temperature control operation mode, may rotate the lower valve body and the upper valve body by a third angle greater than the second angle in the filter closing operation mode, and may rotate the lower valve body and the upper valve body by a fourth angle greater than the third angle in the high-output operation mode.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a 5-way flow control valve and a fuel cell thermal management system using the 5-way flow control valve according to an embodiment of the present disclosure;

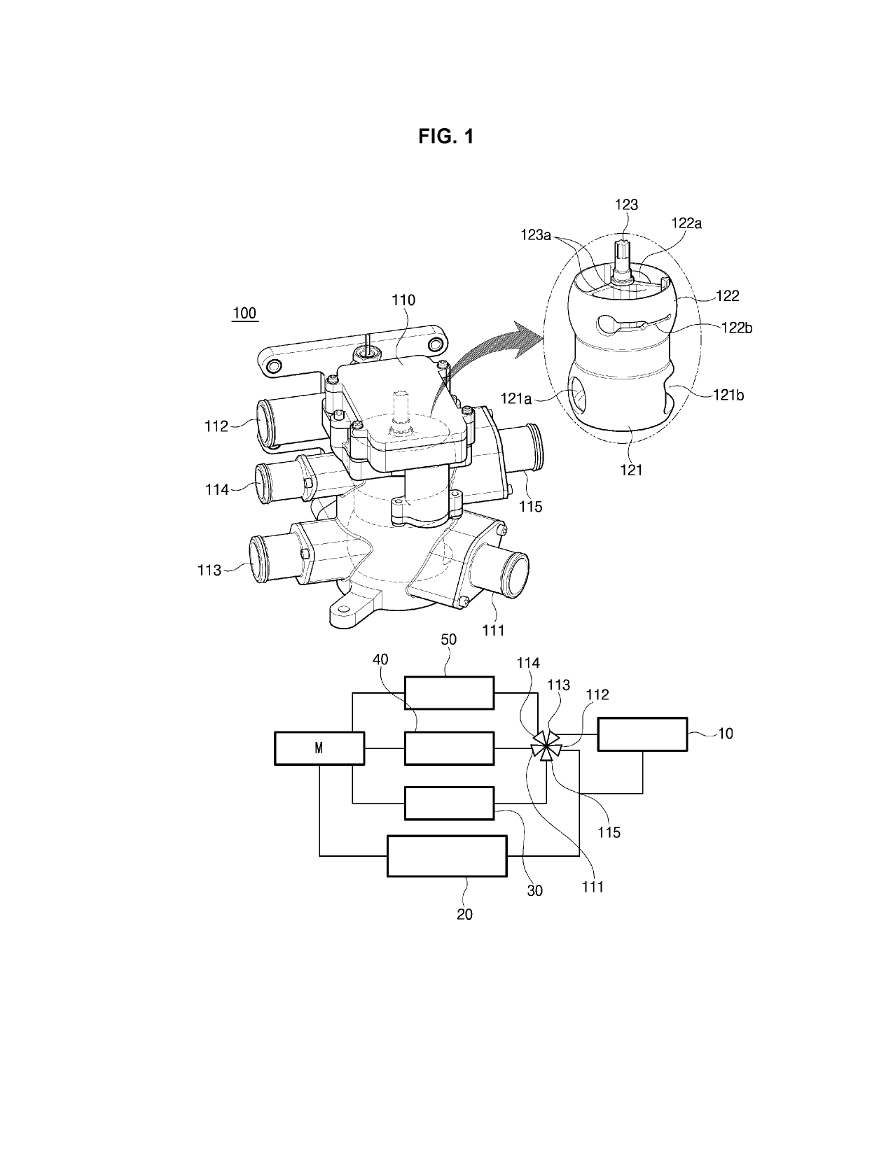

FIG. 2 illustrates opening and closing of flow paths of a 5-way flow control valve in a cold-start operation mode, according to an embodiment of the present disclosure;

FIG. 3 illustrates opening and closing of flow paths of a 5-way flow control valve in a long-steel plate operation mode, according to an embodiment of the present disclosure;

FIG. 4 illustrates opening and closing of flow paths of a 5-way flow control valve in a temperature control operation mode, according to an embodiment of the present disclosure;

FIG. 5 illustrates opening and closing of flow paths of a 5-way flow control valve in a high-output operation mode, according to an embodiment of the present disclosure; and

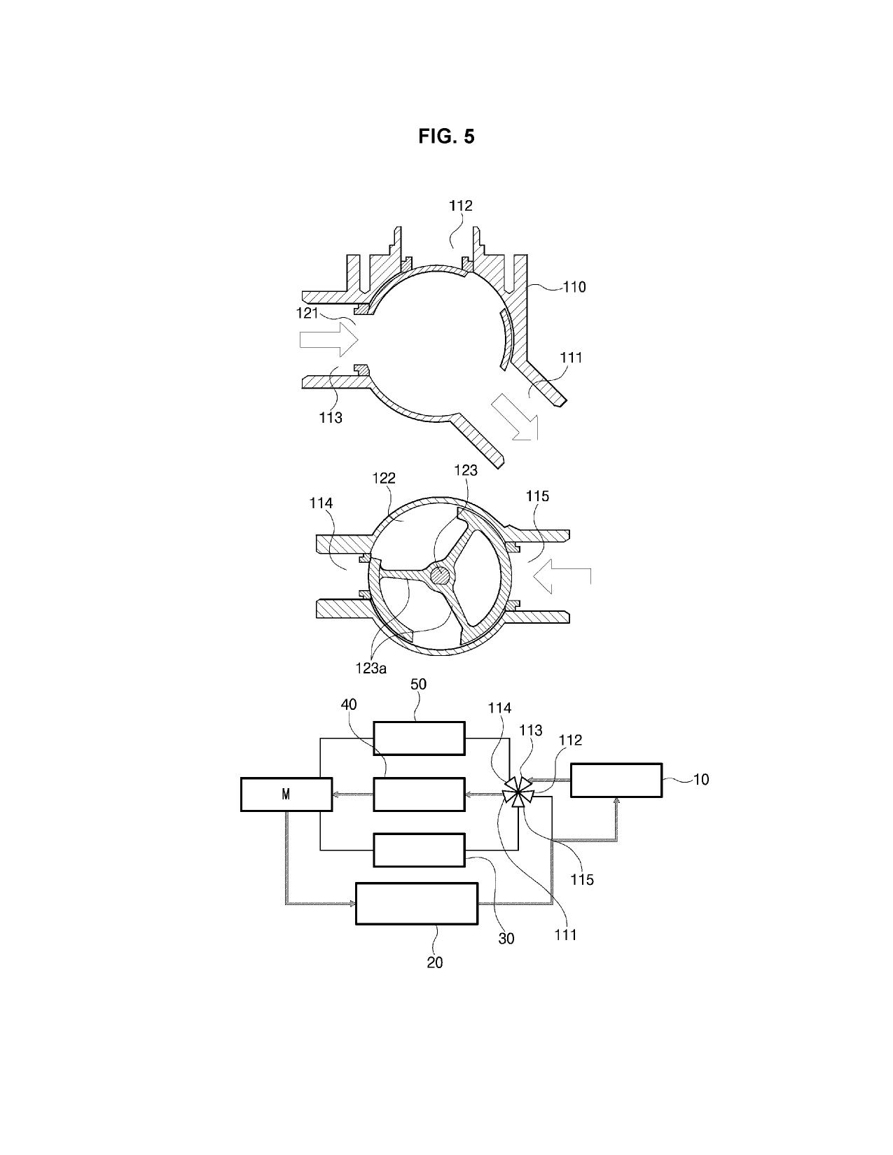

FIG. 6 is a graph illustrating opening-degree areas of flow paths in response to rotation angles of upper and lower valve bodies of a 5-way flow control valve according to an embodiment of the present disclosure.

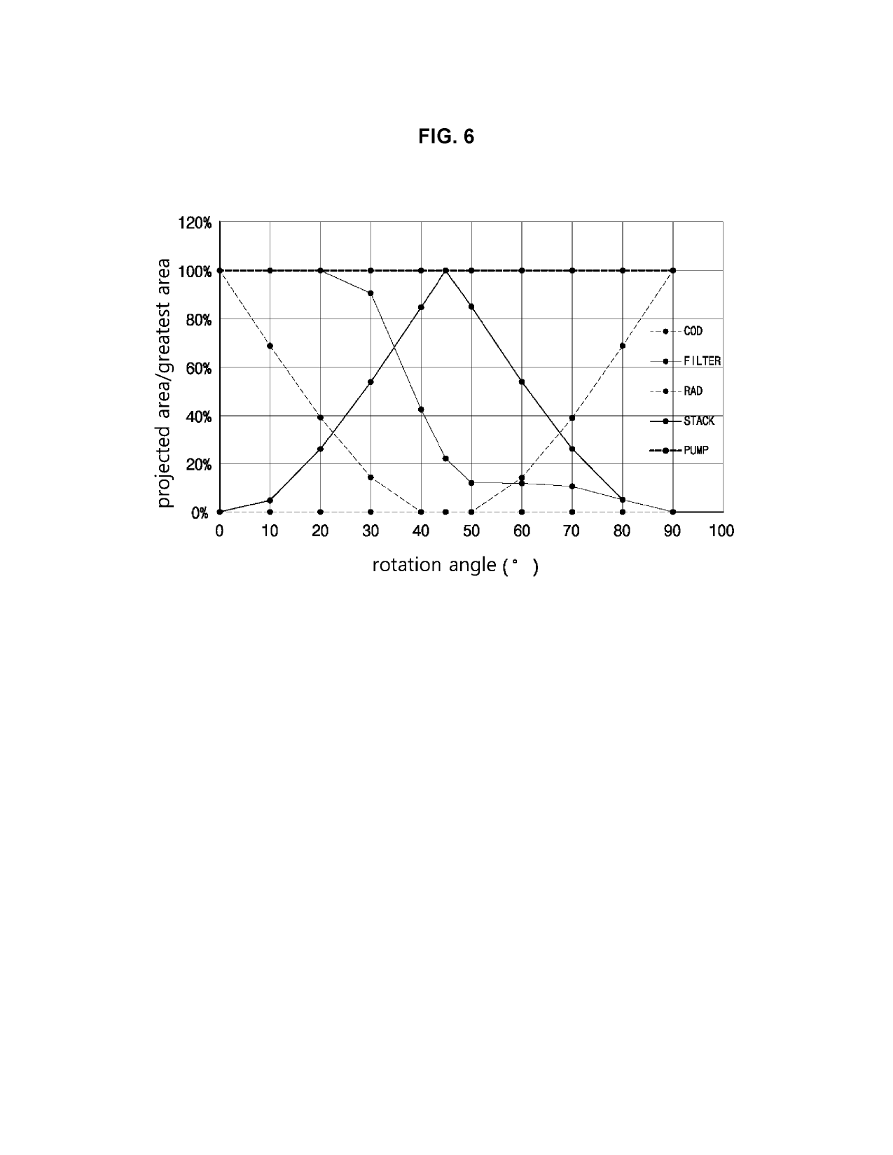

### DETAILED DESCRIPTION

Hereinafter, preferred embodiments of the present disclosure will be described in detail with reference to the attached drawings. Prior to this, the terms and words used in the present specification and claims should not be construed as limited to general or dictionary meanings, and should be construed as meanings and concepts consistent with the technical idea of the present disclosure, based on the principle that inventors may appropriately define concepts of the terms to best describe their inventions.

Therefore, the embodiments described in the present specification and the configurations illustrated in the drawings represent merely the most preferred embodiments of the present disclosure and do not fully represent the technical idea of the present disclosure, and accordingly, it should be understood that there may be equivalent modification example that may replace the embodiments at the time of filing.

The present disclosure relates to a 5-way flow control valve in which a lower valve body and an upper valve body, which are vertically stacked and formed as one body, rotate about a central axis according to an operation mode and multiple flow paths (valves) are interconnected and opened and closed to operate a fuel cell thermal management system with a single valve, and will be described below with reference to the drawings.

First, a 5-way flow control valve 100 according to an embodiment of the present disclosure includes a valve housing 110, an upper valve body 122, a lower valve body 121, and an actuator (not illustrated).

The valve housing 110 includes a first flow path 111, a second flow path 112, a third flow path 113, a fourth flow path 114, and a fifth flow path 115 through which fluids flow in and/or out, and the lower valve body 121 and the upper valve body 122 are provided inside the valve housing 110, and opening and closing and opening degrees of the first to fifth flow paths 111 to 115 are adjusted according to rotation angles of the lower valve body 121 and the upper valve body 122.

In this case, the first flow path 111 is connected to a coolant pump 40 through a fluid flow line, the second flow path 112 is connected to a fuel cell stack 20 through a fluid flow line, the third flow path 113 is connected to a radiator 10 through a fluid flow line, the fourth flow path 114 is connected to an ion filter 50 through a fluid flow line, and the fifth flow path 115 is connected to a heater 30 through a fluid flow line.

Here, the opening and closing and the opening degree of the first flow path 111 to the fifth flow path 115 of the valve housing 110 are determined by rotation angles of the lower valve body 121 and the upper valve body 122 provided inside the valve housing 110.

The lower valve body 121 adjusts opening and closing and opening degrees of the first flow path 111, the second flow path 112, and the third flow path 113 of the valve housing 110, and the upper valve body 122 is stacked over the lower valve body 121 to adjust the opening and closing and opening degrees of the fourth flow path 114 and the fifth flow path 115 of the valve housing 110.

In this case, the lower valve body 121 is preferably in the form of a ball valve having a cavity therein, and has a circular lower short hole 121a through which fluid enters and exits, and an oval lower long hole 121b through which fluid enters and exits.

The lower short hole 121a adjusts opening and closing of the second flow path 112, and the lower long hole 121b adjusts the opening and closing of the third flow path 113.

In addition, the upper valve body 122 has a rotary valve shape in which a rotation shaft 123 is vertically formed at the center thereof in an up-down direction and which is divided into multiple spaces by multiple partition walls 123a in a radial direction around the rotation shaft 123.

In this case, in the upper valve body 122 according to an embodiment of the present disclosure, three partition walls 123a are radially arranged around the rotation shaft 123, and accordingly, an internal space of the upper valve body 122 is divided into three spaces.

Each of the three internal spaces of the upper valve body 122 communicates with an internal space of the lower valve body 121, which is formed as a single internal space.

The upper valve body 122 has one circular upper short hole 122a through which a fluid enters and exits, and one upper long hole 122b, and among the three internal spaces of the upper valve body 122, one is connected to the upper short hole 122a, and another is connected to the upper long hole 122b.

Here, the upper short hole 122a adjusts opening and closing and an opening degree of the fifth flow path 115, and the upper long hole 122b adjusts opening and closing of the fourth flow path.

The rotation shaft 123 formed at the center of the upper valve body 122 is mechanically connected to the actuator, and the actuator 130 rotates the rotation shaft 123 clockwise within a first angle to a fourth angle 1° to 90° depending on a long-steel plate operation mode, a temperature control operation mode, a filter closing operation mode, and a high-output operation mode, with the rotation shaft angle being 0° in the cold-start operation mode.

Therefore, as the rotation shaft 123 selectively rotates within a range of the first angle to the fourth angle 1° to 90° depending on different operation modes based on a rotation axis angle of 0° in the cold-start operation mode, the lower valve body 121 and the upper valve body 122 rotate around the rotation shaft 123 driven by the actuator (not illustrated), and thus, opening and closing and opening degrees of the first to flow path 111 to the fifth flow path 115 are adjusted.

A fuel cell thermal management system using a 5-way flow control valve according to an embodiment of the present disclosure will be described below.

In general, the fuel cell thermal management system may include the radiator 10, the fuel cell stack 20, the heater (cathode oxygen depletion (COD) heater) 30, the coolant pump 40, the ion filter 50, and the 5-way flow control valve 100.

The fuel cell thermal management system uses coolant to discharge reaction heat of the fuel cell stack 20 to the outside of the fuel cell thermal management system, control operation temperature of the fuel cell stack 20, and perform a coolant management function.

In this case, the fuel cell stack 20 may receive air and hydrogen to generate electric power through a chemical reaction, and to release heat which is a byproduct of the chemical reaction of the fuel cell stack 20, coolant may flow to the fuel cell stack 20 and circulate.

In addition, the heater 30 may increase the temperature of the coolant when necessary.

Also, the radiator 10 may re-cool the heated coolant after a chemical reaction of the fuel cell stack 20, and the coolant cooled by the radiator 10 may circulate to the fuel cell stack 20 through the 5-way flow control valve 100.

The coolant pump 40 may supply the coolant transferred from the 5-way flow control valve 100 to the fuel cell stack 20, the heater 30, and the ion filter 50 through a manifold M.

In addition, the ion filter 50 may remove ions included in the coolant, and after the ion filter 50 removes the ions included in the coolant, and the coolant from which the ions are removed may be transferred to the 5-way flow control valve 100.

The 5-way flow control valve 100 adjusts opening and closing of the first flow path 111 to the fifth flow path 115 depending on operation modes of the fuel cell thermal management system.

The fuel cell thermal management system may operate in a total of five operation modes including a cold-start operation mode, a long-steel plate operation mode, a temperature control operation mode, and a high-power operation mode, and the five operation modes are described below.

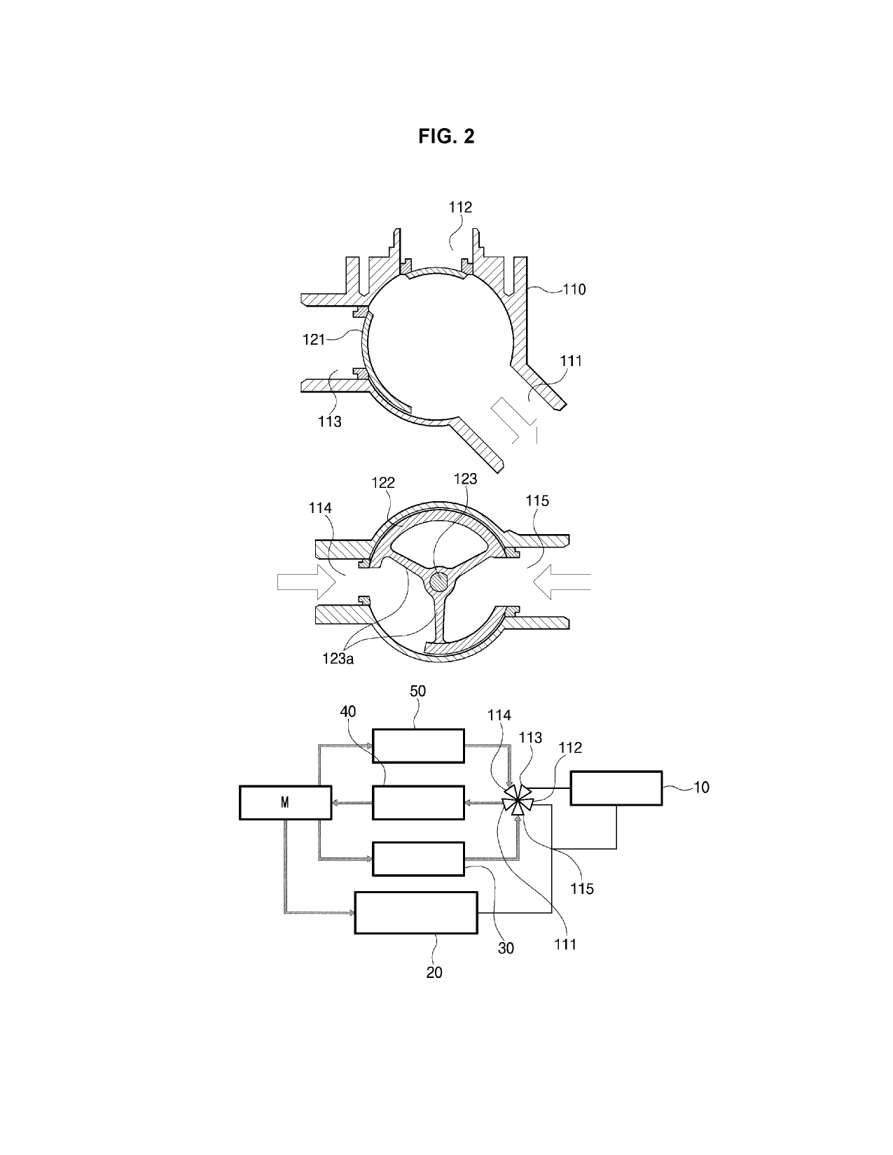

Referring to FIG. 2, in the cold-start operation mode, in order to start the fuel cell stack 20 in a state where the temperature of coolant is below a preset cold start temperature, the coolant heated by the heater 30 is supplied to the fuel cell stack 20 through the manifold M.

In this case, the heater 30 operates in response to the power output from the fuel cell stack 20, and the actuator (not illustrated) of the 5-way flow control valve 100 does not rotate the lower valve body 121 and the upper valve body 122 (rotation angle of the lower valve body 121 and the upper valve body 122 are 0° in the cold-start operation mode), and The lower valve body 121 and the upper valve body 122 cause the first flow path 111, the fourth flow path 114, and the fifth flow path 115 to be maintained in an open state and causes the second flow path 112 and the third flow path 113 to be maintained in a closed state.

Accordingly, the coolant pumped by the coolant pump 40 branches off from the manifold M and flows to the heater 30 and the ion filter 50, and the coolant circulating through the heater 30 and the ion filter 50 is collected to the 5-way flow control valve 100 and then flows back to the coolant pump 40 and circulates.

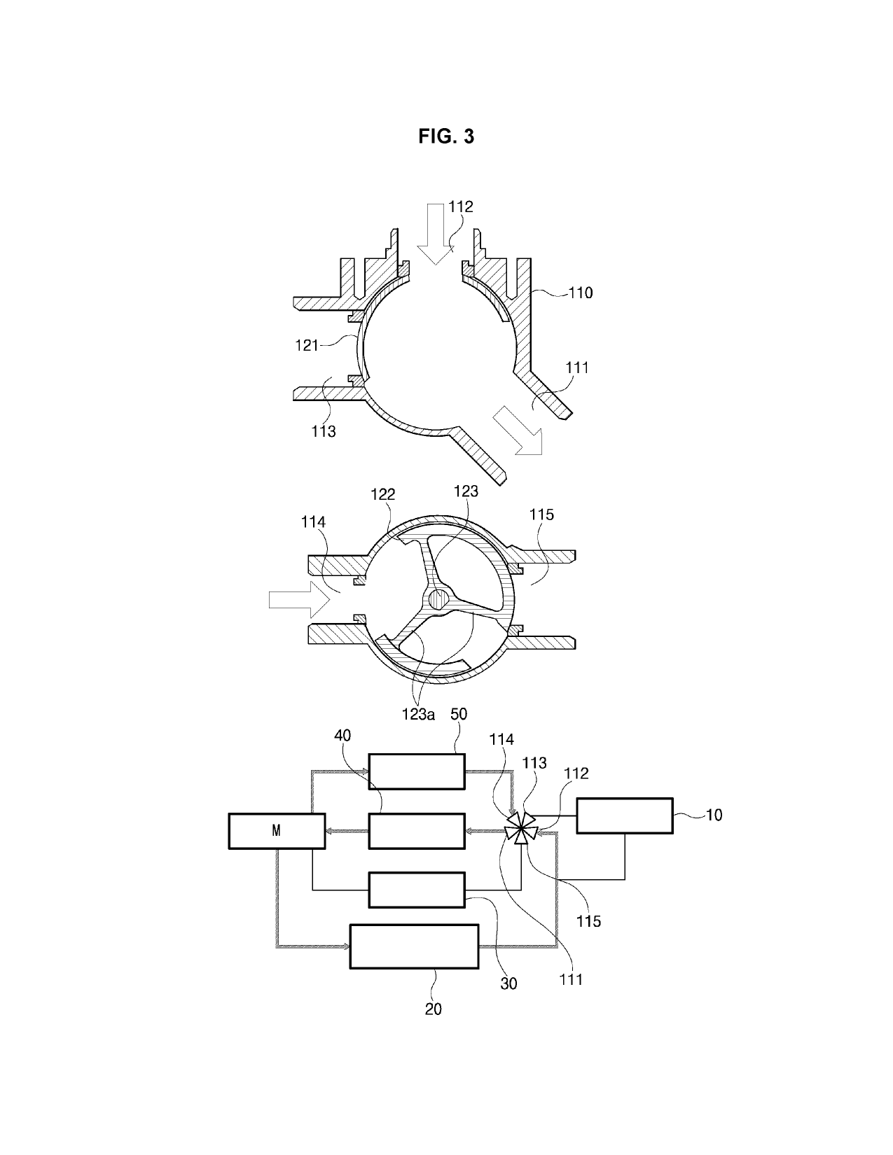

Referring to FIG. 3, in the long-steel plate operation mode, when a temperature of a coolant is sufficiently increased by the heater 30 in the cold-start operation mode, the coolant having the temperature increased to a certain temperature passes through the fuel cell stack 20.

In this case, the actuator (not illustrated) of the 5-way flow control valve 100 rotates the lower valve body 121 and the upper valve body 122 by a first angle, and thereby, the first flow path 111, the second flow path 112, and the fourth flow path 114 are opened, and the third flow path 113 and the fifth flow path 115 are closed by the lower valve body 121 and the upper valve body 122 (here, the first angle has a rotation angle ranging from 1° to 45° based on the rotation angle of 0° in the cold-start operation mode).

Therefore, the coolant pumped by the coolant pump 40 is branched from the manifold M and flows to the fuel cell stack 20 and the ion filter 50, and the coolant circulating through the fuel cell stack 20 and ion filter 50 is collected to the 5-way flow control valve 100 and then flows back to the coolant pump 40.

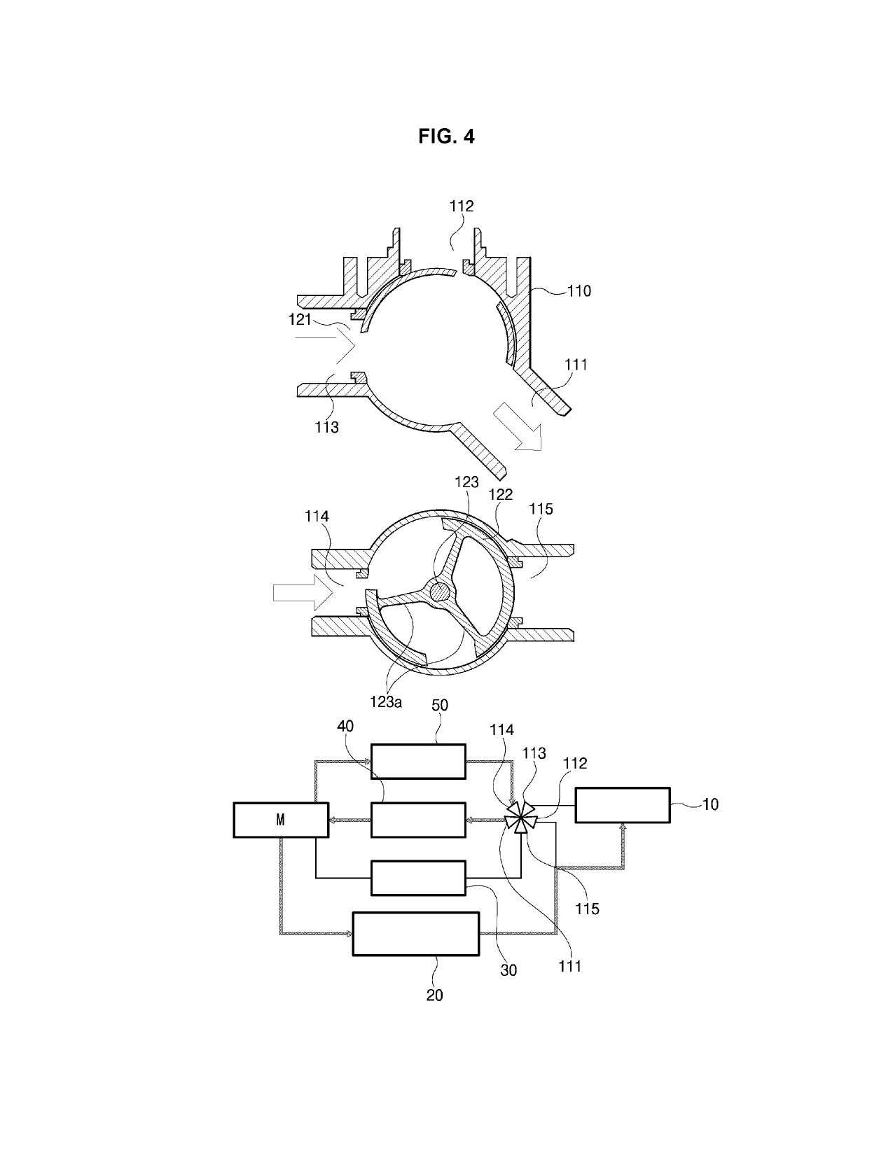

Referring to FIG. 4, the temperature control operation mode is a period in which the fuel cell stack 20 normally operates after the long-steel plate operation mode, and is a mode in which a temperature of the fuel cell stack 20 is controlled.

In this case, the actuator (not illustrated) of the 5-way flow control valve 100 rotates the lower valve body 121 and the upper valve body 122 by a second angle greater than the first angle, and thereby, the first flow path 111 and the fourth flow path 114 are opened, the third flow path 113 is opening, the fifth flow path 115 is closed, and the second flow path 112 is closing by the lower valve body 121 and the upper valve body 122 (here, the second angle has a rotation angle ranging from 46° to 80°, which is greater than the greatest rotation angle of 45° in the long-steel plate operation mode).

Therefore, the coolant pumped by the coolant pump 40 is branched from the manifold M and flows to the fuel cell stack 20 and the ion filter 50, and the coolant heated in the fuel cell stack 20 flows to the radiator 10 for cooling, and then flows to the radiator 10 to be cooled, and flows back to the coolant pump 40 through the 5-way flow control valve 100. Meanwhile, the coolant circulating through the ion filter 50 is also collected to the 5-way flow control valve 100 and then flows back to the coolant pump 40.

A flow rate of the coolant circulating through the manifold M and radiator 10 is 114 LPM, and a flow rate of the coolant circulating through the ion filter 50 is 6 LPM (the total flow rate of the coolant is 120 LPM).

In addition, in the filter closing operation mode, a flow rate of the coolant flowing to the ion filter 50 is reduced, the actuator (not illustrated) of the 5-way flow control valve 100 rotates the lower valve body 121 and the upper valve body 122 by a third angle greater than the second angle, and thereby, the first flow path 111 is opened, the third flow path 113 is opening, the fifth flow path 115 and the second flow path 112 are closed, and the fourth flow path 114 is closing by the lower valve body 121 and the upper valve body 122 (here, the third angle has a rotation angle ranging from 81° to 89°, which is greater than the greatest rotation angle of 80° in the temperature control operation mode).

In addition, the high-power operation mode may be a period in which the fuel cell stack 20 operates at its maximum after the temperature control operation mode. In the high-power operation mode, all of the coolant discharged from the fuel cell stack 20 may flow to the radiator 10 to cool again the coolant having the temperature increased by an operation of the fuel cell stack 20.

Therefore, the actuator (not illustrated) of the 5-way flow control valve 100 rotates the lower valve body 121 and the upper valve body 122 by a fourth angle greater than the third angle, and thereby, the first flow path 111 and the third flow path 113 are opened, and the second flow path 112, the fourth flow path 114, and the fifth flow path 115 are closed by the lower valve body 121 and the upper valve body 122 (here, the fourth angle has a rotation angle of 90° greater than the greatest rotation angle of 89° in the filter closing operation mode).

Here, when the fuel cell thermal management system ends an operation, the actuator (not illustrated) of the 5-way flow control valve 100 reversely rotates the lower valve body 121 and the upper valve body 122 by 90°, and the lower valve body 121 and the upper valve body 122 return to the cold-start operation mode.

Also, after the heater 30 is turned off in the operation mode described above and the cold-start operation mode is activated, a valve position ratio is 47% for the manifold, 47% for the radiator, and 6% for the ion filter.

Also, when the temperature of an outlet of the coolant pump 40 is 65°C or more, it is preferable to increase an opening ratio of the radiator 10 or a flow rate of the coolant pump 40.

The 5-way flow control valve according to the present disclosure has following effects.

A lower valve body and an upper valve body, which are vertically stacked and formed as one body, rotate about a central shaft according to an operation mode and multiple flow paths (valves) are interconnected and open and closed to operate a fuel cell thermal management system with a single valve.

Although the present disclosure is described with reference to the embodiments illustrated in the drawings, these are merely examples, and those skilled in the art will understand that various modifications and equivalent embodiments may be derived therefrom. Therefore, the true technical protection scope of the present disclosure should be defined by the technical idea of the appended claims.

What is claimed is:

1. A 5-way flow control valve for controlling a flow and flow rate of a coolant in a fuel cell system including a radiator, a fuel cell stack, a heater, a coolant pump, and an ion filter, the 5-way flow control valve comprising:
a valve housing including a first flow path communicating with the coolant pump, a second flow path communicating with the fuel cell stack, a third flow path communicating with the radiator, a fourth flow path communicating with the ion filter, and a fifth flow path communicating with the heater;
a lower valve body configured to selectively rotate inside the valve housing to adjust opening and closing and opening degrees of the first flow path, the second flow path, and the third flow path of the valve housing;
an upper valve body stacked above the lower valve body and configured to selectively rotate inside the valve housing to adjust opening and closing and opening degrees of the fourth flow path and the fifth flow path of the valve housing; and
an actuator located outside the valve housing and connected to at least one of the upper valve body and the lower valve to rotate the lower valve body and the upper valve body, which are stacked to each other and formed as one body, about a center axis according to an operation mode.

2. The 5-way flow control valve of claim 1, wherein the lower valve body has a ball valve shape.

3. The 5-way flow control valve of claim 1, wherein the upper valve body includes a rotational shaft extending vertically at a center of an internal space of the upper valve body, and is divided into three spaces by three partition walls radially arranged around the rotational shaft.

4. The 5-way flow control valve of claim 3, wherein each of the three internal spaces of the upper valve body communicates with an internal space of the lower valve body.

5. The 5-way flow control valve of claim 4, wherein the actuator rotates the lower valve body and the upper valve body about the rotational shaft according to one of a long-steel plate operation mode, a temperature control operation mode, a filter closing operation mode, and a high-output operation mode based on an angle of the rotational axis in a cold-start operation mode.

6. The 5-way flow control valve of claim 5, wherein the actuator does not rotate the lower valve body and the upper valve body in the cold-start operation mode, rotates, in the long-steel plate operation mode, the lower valve body and the upper valve body by a first angle based on an angle of 0° in the cold-start operation mode, rotates the lower valve body and the upper valve body by a second angle greater than the first angle in the temperature control operation mode, rotates the lower valve body and the upper valve body by a third angle greater than the second angle in the filter closing operation mode, and rotates the lower valve body and the upper valve body by a fourth angle greater than the third angle in the high-output operation mode.
